(19) United States
(12) Patent Application Publication
(10) Pub. No.: US 2006/0131948 A1
(43) Pub. Date: Jun. 22, 2006

(54) Vehicle traction assist device

(76) Inventor: Martin Daniel Holmes, Shafter, CA (US)

Correspondence Address: MARTIN HOLMES, 5225 DEER CREEK WAY, PASO ROBLES, CA, 93446, US

(21) Appl. No.: 11/015,697

(22) Filed: Dec. 16, 2004

(51) Int. Cl. B60B 11/10

(52) U.S. Cl. 301/40.1

(57) ABSTRACT

The present invention provides a device which will provide enhanced traction on soft terrains yet allow the vehicle to operate on a hardened surface without requiring removal. Briefly, the present invention provides an auxiliary traction-enhancing device for use with a wheeled vehicle during traverse of soft terrain. The device is fully retractable to less that the diameter of the existing wheel hub and usually within the confines of the wheel well fender. When extended, the device provides an additional footprint greater than that of the existing tire. As the contact to the terrain is through a pliable material the footprint will mold to the terrain to better facilitate traction.

CROSS-REFERENCE TO RELATED APPLICATIONS:

| | | | |
|---|---|---|---|
| 1466995 | September, 1923 | Denault | 152/185. |
| 1599001 | September, 1926 | Anderson et al. | 152/208. |
| 3675701 | July, 1972 | Garrison | 152/225. |
| 3871720 | March, 1975 | Mosshart et al. | 152/185. |
| 4323102 | April, 1982 | Hall | 152/185. |
| 4408646 | October, 1983 | Forsyth | 152/185. |
| 1102274 | July, 1914 | Kelly | 301/40. |
| 1404051 | January, 1922 | Ollivier | 301/45. |
| 1497092 | June, 1924 | Delieuvin | 301/45. |
| 4402357 | September, 1983 | Granryd | 152/218. |
| 4508150 | April, 1985 | Granryd | 152/225. |
| 4603916 | August, 1986 | Granryd | 152/213. |
| 4694872 | September, 1987 | Granryd | 152/216. |
| 882348 | March, 1908 | Schindler | 152/96. |
| 2171844 | September, 1939 | Chaffin | 301/50. |
| 3178232 | April, 1965 | Ealey et al. | 301/51. |
| 3380779 | April, 1968 | Albright | 301/38. |
| 901842 | October, 1908 | Shattuck | 301/44. |
| 1235557 | August, 1917 | Dailey | 301/44. |
| 2240261 | April, 1941 | Hodell | 301/44. |
| 3014547 | December, 1961 | Lely | 301/41. |
| 3206253 | September, 1965 | Bedan et al. | 301/44. |
| 3707308 | December, 1972 | Smith | 301/44. |
| 4533183 | August, 1985 | Gant. | |
| 5242214 | September, 1993 | Granryd | |
| 5692810 | December, 1997 | Granryd | 416/74. |
| 1865882 | July, 1932 | Palmer | 301/41. |
| 2108346 | February, 1938 | Paul | 416/74. |
| 2377195 | May, 1945 | Van De Hey | 89/40. |
| 2754874 | October, 1952 | Gardner | 152/158. |
| 2947336 | February, 1959 | Gutierrez | 152/216. |
| 3016078 | May, 1960 | Schmidt | 152/216. |
| 3071173 | September, 1961 | Hoffmann | 152/216. |
| 3078902 | November, 1961 | Scheiduinger | 152/216. |
| 3861752 | January, 1975 | Thurre et al. | 152/216. |
| 4576214 | March, 1986 | Preusker | 152/213. |
| 4852948 | August, 1989 | Vagias | 152/216. |
| 5156695 | October, 1992 | Martin | 152/213. |
| 2443406 | June, 1948 | Thompson | 152/216. |
| 2598851 | June, 1952 | Spevak | 152/216. |
| 2709115 | May, 1955 | Nisser | 152/225. |
| 3045738 | July, 1962 | Lombardi | 301/43. |
| 3117612 | January, 1964 | Minutua | 301/41. |
| 3132682 | May, 1964 | Fox | 152/225. |
| 3249143 | May, 1966 | Scott | 152/216. |
| 3478803 | November, 1969 | Sand | 152/216. |
| 3753456 | August, 1973 | Saunders | 152/225. |
| 3911985 | October, 1975 | Fletcher | 152/225. |
| 3935891 | February, 1976 | McCloud et al. | 152/225. |
| 4089359 | May, 1978 | Jones | 152/208. |
| 1568937 | January, 1926 | Zwalsh | 152/225. |
| 1572806 | February, 1926 | Peterson et al. | 152/216. |
| 5046785 | September, 1991 | Bockerman | 301/40. |

### STATEMENT REGARDING FEDERALLY SPONSORED RESEARCH OR DEVELOPMENT

Not Applicable

### BACKGROUND OF THE INVENTION

Since the invention of the automobile wheel inventors have endeavored to improve traction without having a detrimental effect to the handling character of the vehicle. This is particularly advantageous to the military and off-road vehicles. Whilst off-road tires have been developed these usually have a detrimental effect on highway usage or are illegal. Many inventions utilize the idea of a secondary wheel device attached to the original wheels. These are usually heavy and take time to attach and detach and have a detrimental effect on the handling of the vehicle when on the highway.

There are numerous devices and patents that have attempted to address the problem of additional traction for wheeled vehicles in soft terrain, but to also maintain the vehicles ability to continue using the highway.

Most of these fail in 4 major areas:
1) Unacceptable weight and loss of fuel economy.
2) Unacceptable width to vehicle on the highway.
3) Time consuming setup/installation
4) A Fixed profile doesn't take into account differing consistency of ground conditions

### BRIEF SUMMARY OF THE INVENTION

The present invention provides a device which can be easily installed in a minimum amount of time. The device will provide enhanced traction on soft terrains yet allow the vehicle to operate on a hardened surface without requiring removal. Briefly, the present invention provides an auxiliary traction enhancing device for use with a wheeled vehicle during traverse of soft terrain. The device is fully retractable to less that the diameter of the existing wheel hub and usually within the confines of the wheel well fender. When extended, the device provides an additional footprint greater than that of the existing tire. As the contact to the terrain is through a pliable material the footprint will mold to the terrain to better facilitate traction.

### BRIEF DESCRIPTION OF THE SEVERAL VIEWS OF THE DRAWING

FIG. 1. front isometric view of vehicle wheel with vehicle traction assist device attached in the extended position.

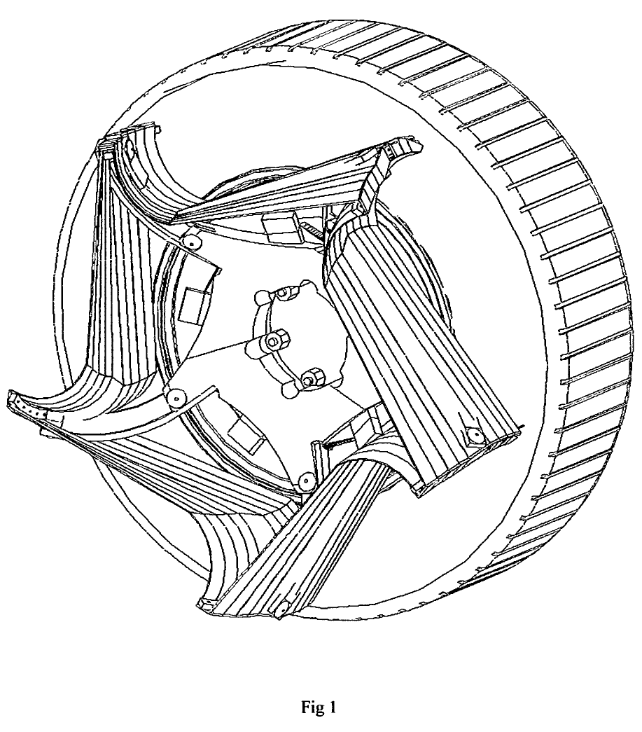

FIG. 2. front view of vehicle wheel with vehicle traction assist device attached in the extended position.

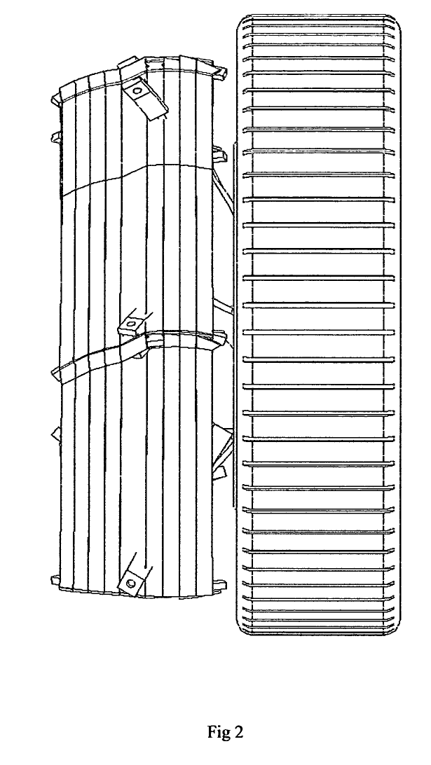

FIG. 3. side view of vehicle wheel with vehicle traction assist device attached in the extended position.

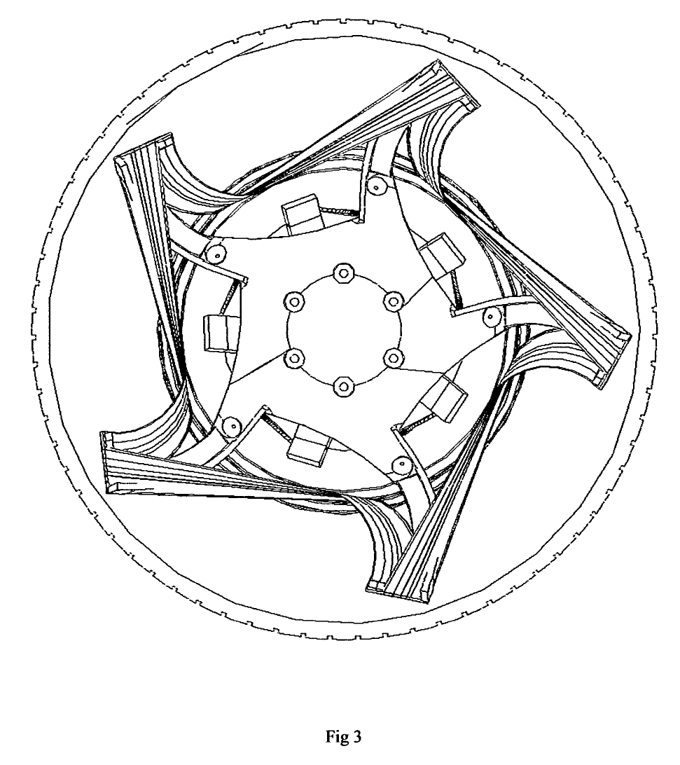

FIG. 4 Isometric view of vehicle wheel with vehicle traction assist device attached in the extended position without the pliable material.

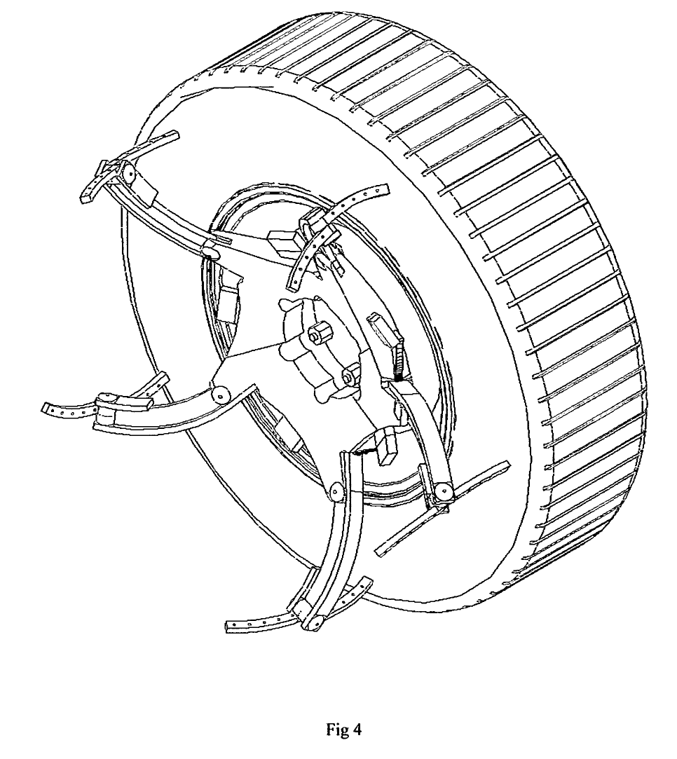

FIG. 5. front view of vehicle traction assist device without pliable material.

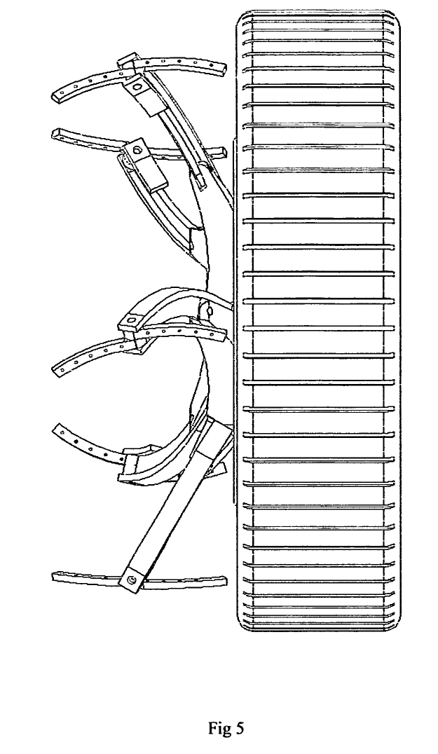

FIG. 6. front view of vehicle traction assist device hub

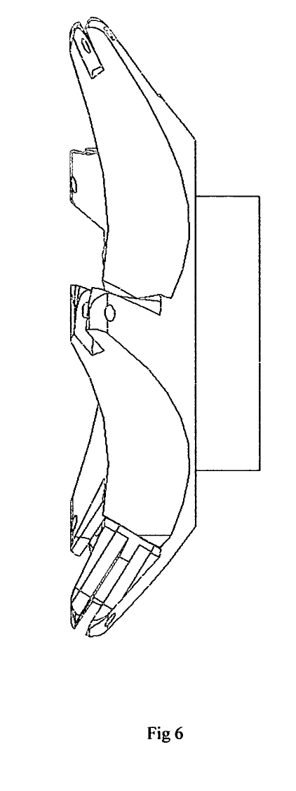

FIG. 7. side view of vehicle traction assist device hub

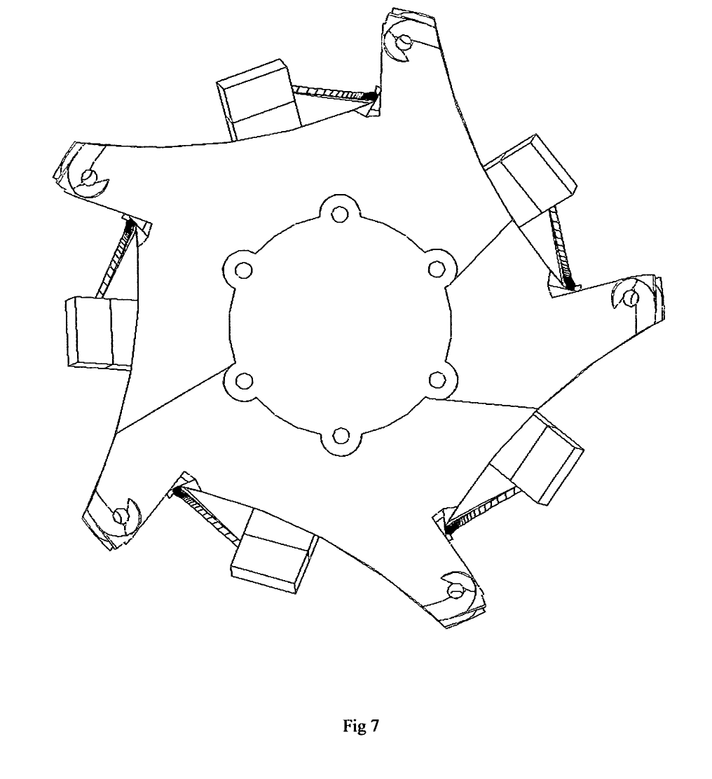

FIG. 8. rear isometric view of vehicle traction assist device in the extended position without the pliable material.

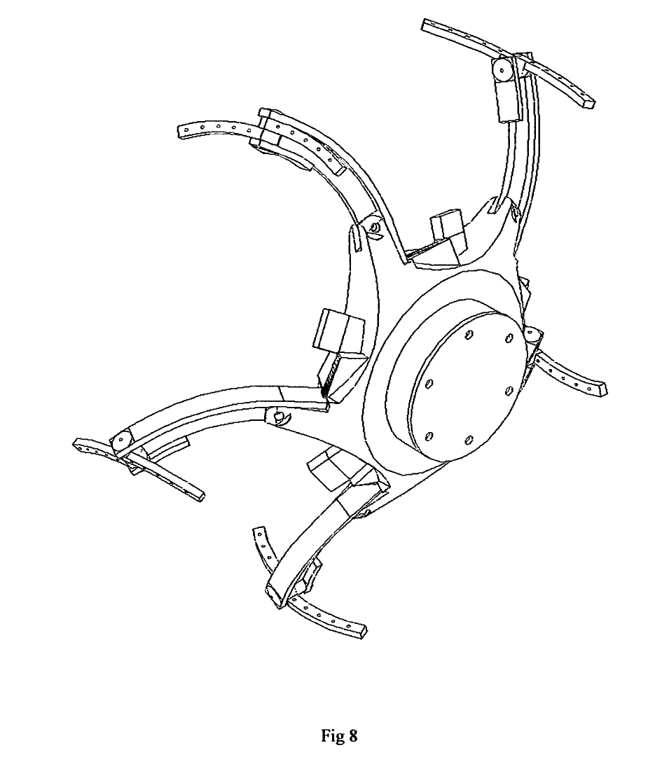

FIG. 9. front Isometric view of vehicle wheel with vehicle traction assist device attached in retracted position.

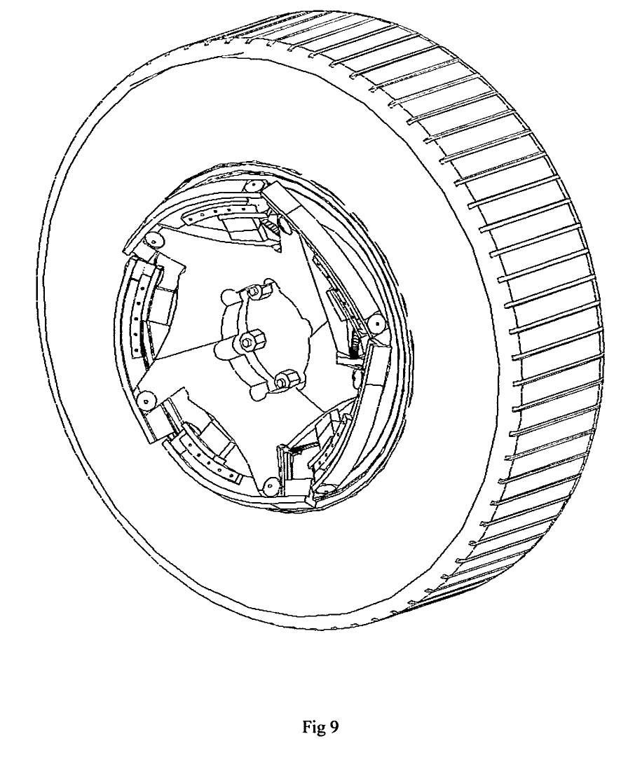

FIG. 10. front view of vehicle wheel with vehicle traction assist device attached in retracted position.

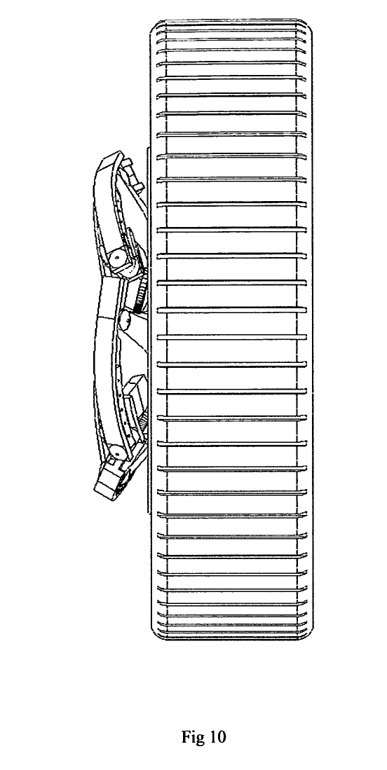

FIG. 11. front Isometric view of vehicle traction assist device in retracted position.

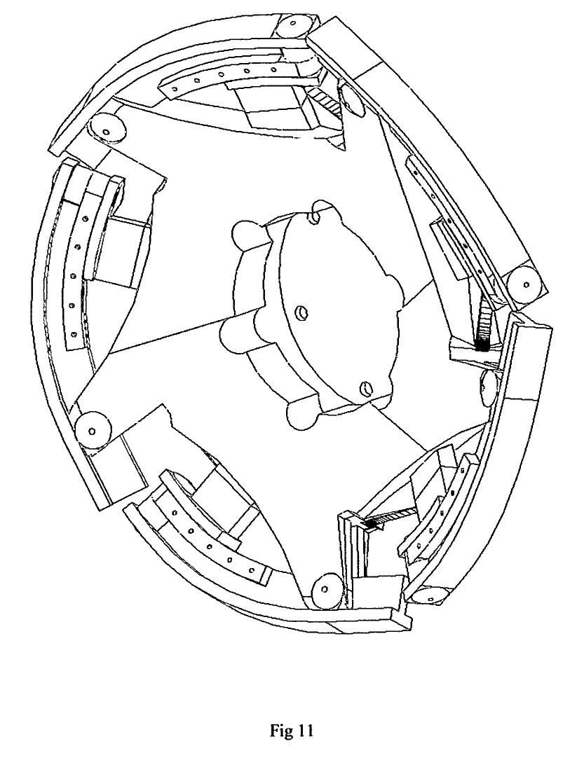

### DETAILED DESCRIPTION OF THE INVENTION

An apparatus for providing additional traction to the wheels of a vehicle utilizes an attachment for use with a variety of sizes of vehicle wheels and has features to permit its utilization when needed. The device reduces to a size not exceeding the diameter of the wheel hub when not required for traction. The traction enhancement device provides added traction when the vehicle is used on soft terrain including mud, sand or snow. The device secures to the vehicle axle by use of the existing arrangement of wheel lugs and nuts (drawing 1). The traction device includes a bowl shaped center attached to the wheel lugs. A plurity of legs protrude from the outer edge of the bowl extending to a distance less than the outer diameter of the tire. The legs are connected to the bowl by a pivot and can extend perpendicular to the wheel center or can retract to be parallel to the circumference of the bowl. At the outer edge of the legs are retractable pivoting feet. When the legs are extended the feet are in the open position creating a T shape. When the legs are retracted the feet reside parallel to the legs (drawing 9). Connected along the length of the feet, and parallel to the tire tread plane, is a hard wearing porous pliable material. When the device is in use the ensemble acts similar to a wheel that would be attached to the outer face of an existing wheel (drawing 1). The legs are held in the retracted position by magnets (drawing 10) designed to allow the legs to extend when the centrifugal force is greater than the holding force of the magnet (i.e. when the wheel reaches a certain spin speed). The pliable material is not taught when the legs and feet (drawing 1) are extended causing the material to mold to the ground surface and also to allow access water from the terrain to pass through. Apart from the pliable material all materials are to be made from hardened steel or a hard enough metal to resist any forces acting upon any member. The pliable material should be tough enough to resist tearing when in use, the inventor considering Kevlar as a premier choice.

There are numerous devices and patents that have attempted to address the problem of additional traction for wheeled vehicles in soft terrain, but to also maintain the vehicles ability to continue using the highway. For the sake of brevity I have summarized the major areas these prior inventions fail to address.

Most of these fail in 4 major areas:
5) Unacceptable weight and loss of fuel economy.
6) Unacceptable width to vehicle on the highway.
7) Time consuming setup/installation
8) A Fixed profile doesn't take into account differing consistency of ground conditions

The Vehicle traction assist device addresses all these problems whereas no one single invention in this area has adequately done so before.

What I claim as my invention is:

1; A retractable traction device for wheeled vehicles, comprising:
a) a bowl shaped hub for securing the device to a wheel of a vehicle;
b) a plurity of legs pivoting from the circumference of the hub;
c) 2 feet pivoting from the ends of the legs opposite to the hub/leg connection;
d) a hard wearing porous pliable material connected to the feet in a continuous loop around the device;
e) latches for securing the device in the retracted and extended positions;

2; A retractable traction device as in claim 1, wherein:
a) said legs pivot from a position parallel of the hub circumference to a position perpendicular to the hub circumference between angles of 10° and 45° from the outside face of the wheel;
b) said legs are lockable in extended and retracted positions;

3; A retractable traction device as in claim 1, wherein:
a) said feet are connected via a pivot to the legs at the outer circumference of the device;
b) said feet pivot from a position parallel to either side of the legs to positions perpendicular to the legs and perpendicular to the outside wheel face;
c) said feet are lockable in extended and retracted positions;

4; A retractable traction device as in claim 1, wherein:
a) said pliable material is connected along the length of each foot;
b) said pliable material will fold and unfold with the movement of the feet;
c) said pliable material acts as a second wheel when the device is used for added traction;
d) said pliable material reacts to the terrain with an adaptable foot print;
e) said pliable material is porous to allow terrain moisture through;

5) A retractable traction device as in claim 1, wherein:
a) said legs are held in the retracted position by magnets, when the wheel centrifugal force exceeds the resistance of the magnets the legs and feet extend to allow additional traction (i.e. when the wheel reaches a certain spin velocity);
